(19) United States
(12) Patent Application Publication
(10) Pub. No.: US 2022/0147120 A1
(43) Pub. Date: May 12, 2022

(54) STOWABLE ACCESSORY DOCKS

(71) Applicant: Hewlett-Packard Development Company, L.P., Spring, TX (US)

(72) Inventors: Xiang Ma, Spring, TX (US); Baosheng Zhang, Spring, TX (US); Richard S. Lin, Spring, TX (US); Fangyong Dai, Spring, TX (US)

(73) Assignee: Hewlett-Packard Development Company, L.P., Spring, TX (US)

(21) Appl. No.: 17/296,640

(22) PCT Filed: Jul. 31, 2019
(86) PCT No.: PCT/US2019/044553

§ 371 Date: May 25, 2021

(51) Int. Cl. G06F 1/18

(52) U.S. Cl. CPC G06F 1/182

(57) ABSTRACT

In an example, a stowable accessory dock may include an accessory loop and a movable tray disposed adjacent the accessory loop and movable between a stowed position disposed within a housing of an electronic device and a deployed position extending out from the housing. Further, the accessory loop is engageable with the movable tray such that the movable tray is to insert the accessory loop into the housing upon the movable tray being transitioned to the stowed position.

### BACKGROUND

Electronic devices such as computing devices may be utilized in various ways. In some situations, electronic devices may be interacted with by a user through various types of interfaces, for example, mice, trackpads, keyboards, etc. In some situations, electronic devices may include a display, which may be a touch screen display. A user may interact with a touch screen display by touching by hand, or by using an accessory, such as a stylus or electronic pen.

### BRIEF DESCRIPTION OF THE DRAWINGS

FIG. 1A is a partial perspective view of an example stowable accessory dock disposed in a deployed position.

FIG. 1B is a partial perspective view of an example stowable accessory dock disposed in a stowed position.

FIG. 2A is a perspective view of an example movable tray of an example stowable accessory dock.

FIG. 2B is a partial perspective view of an example housing having an example stowable accessory dock.

FIG. 2C is a partial perspective view of an example housing having an example stowable accessory dock.

FIG. 2D is a partial perspective view of an example housing having an example stowable accessory dock.

FIG. 3 is a cutaway side view of an example housing having an example stowable accessory dock in various positions.

FIG. 4 is a perspective view of an example electronic device having an example stowable accessory dock.

### DETAILED DESCRIPTION

As described above, electronic devices such as computing devices may be utilized in various ways. In some situations, electronic devices may be interacted with by a user through various types of interfaces, for example, mice, trackpads, keyboards, etc. In further situations, electronic devices may include a display on which content may be output or shown to a user. The display may be a standalone monitor or screen for a desktop computer in some examples, or may be an integrated screen, for example, in a laptop or notebook computer, or a tablet computer. Other examples may include a display or screen on a different type of electronic device, for example, an imaging device such as a printer, or an additive manufacturing machine such as a three-dimensional (3D) printer. In some situations, the display of an electronic device may be a touch screen display. A user may interact with a touch screen display by touching by hand, or by using an accessory, such as a stylus or electronic pen.

An accessory such as a stylus or electronic pen can be a useful tool in interacting with an electronic device such as a computer having a touch screen display. For example, such an accessory may be used to write notes on a display, mimicking a pad of paper or a sticky note, or may further be used to draw or sketch on a display in order to generate electronic drawings or graphic designs.

Such accessories are often stored separate from an electronic device, for example in a user's bag or pocket. Due to the relatively small size of the accessory, this can result in the user inadvertently losing the accessory, or not being able to locate the accessory among other items in the bag. Some electronic devices may include a slot or channel into which the stylus, electronic pen, or other accessory may be inserted in order to be stowed. This solution may take up valuable space or volume within the chassis of the electronic device, where space is often at a premium. In other situations, an additional holding accessory, such as a stick-on or attachable loop, may be able to be attached externally to the electronic device in order to hold the accessory to the electronic device while stowed. Such methods of stowing an accessory may be cumbersome or ugly and not match the industrial design or aesthetics of the electronic device, may not hold the accessory securely enough to the electronic device, and/or may incur additional cost to the user.

In some situations, it may be desirable to employ an accessory dock with an electronic device that may securely hold an accessory, such as a stylus or electronic pen, while stowed, may occupy a minimum amount of internal volume of the chassis of the electronic device, and may have a discrete or favorable appearance, or may match the aesthetic or industrial design of the electronic device. Implementations of the present disclosure provide stowable accessory docks that are discrete and blend in with the overall aesthetic of an electronic device, and that can securely hold an accessory of the electronic device when deployed.

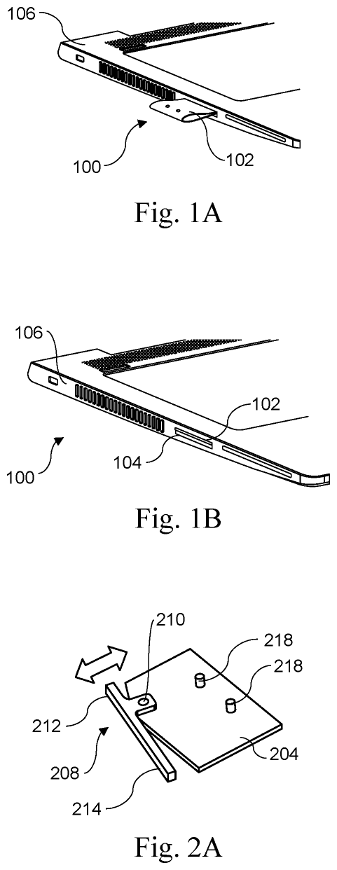

Referring now to FIGS. 1A-1B, a partial perspective view of an example stowable accessory dock 100 is illustrated. FIG. 1A illustrates the stowable accessory dock 100 as being deployed, while FIG. 1B illustrates the stowable accessory dock 100 as being stowed. Example stowable accessory dock 100 may be implemented or installed into a housing 106 for an electronic device. Further, example stowable accessory dock 100 may include an accessory loop 102 and a movable tray 104 disposed adjacent the accessory loop 102 and movable between a stowed position disposed within the housing 106 of an electronic device and a deployed position (not shown) extending out from the housing 106. The movability of the movable tray 104 is described in more detail below. Further, the accessory loop 102 is engageable with the movable tray 104 such that the movable tray 104 is to insert the accessory loop into the housing 106 upon the movable tray 104 being transitioned to the stowed position.

The accessory loop 102 may be a component that is able to receive and retain an accessory for an electronic device. In some implementations, the accessory loop 102 may be a pliable or flexible component, and/or be constructed of a pliable or flexible material. In some implementations, the accessory loop 102 may be constructed of a fabric, polymer, rubber, or some other type of pliable material. The accessory loop 102 may be sufficiently bendable, pliable, or soft, such that it may be folded onto itself or compressed flat, and also able to be expanded to form an internal channel or slot to receive an accessory.

In some implementations, the accessory loop 102 may be installed into a housing 106 for an electronic device such that the accessory loop 102 is movable from a stowed position, disposed within the housing 106, and a deployed or extended position, extending from an exterior surface of the housing 106. The accessory loop 102 may be attached to an interior portion or cavity within the housing 106, and may be disposed adjacent an aperture, window, slot, or other opening in the exterior surface of the housing 106. Thus, the accessory loop 102 may be able to be disposed within the housing 106 in the hidden or stowed position, and also be pulled or extended through the opening in order to be disposed in the deployed position and able to receive and retain an accessory for the electronic device.

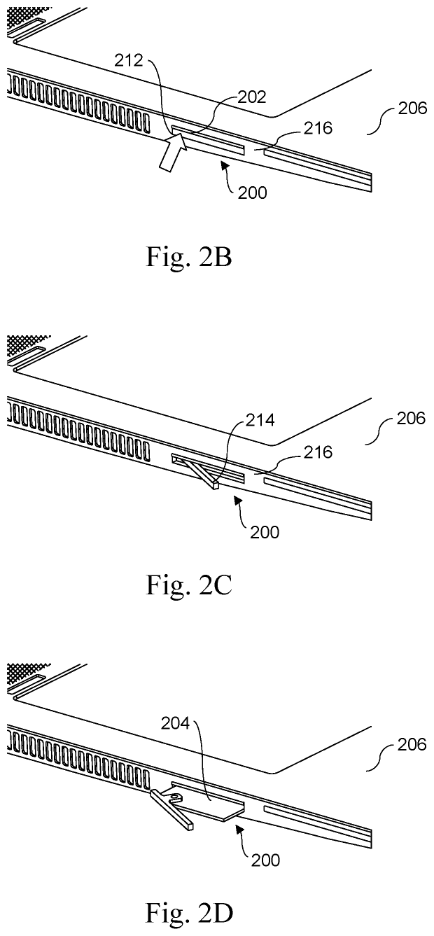

Referring now to FIG. 2A, a perspective view of an example movable tray 204 is illustrated. Referring additionally to FIGS. 2B-2D, partial perspective views of an example housing having an example stowable accessory dock 200 in various positions are illustrated. Example stowable accessory dock 200 may be similar to example accessory dock 100, described above. Further, the similarly-named elements of example accessory dock 200 may be similar in function and/or structure to the respective elements of example accessory dock 100, as they are described above. Stowable accessory dock 200 may include an accessory loop (not shown) and a movable tray 204, as shown in FIG. 2A. Each FIGS. 2B-2D illustrates the movable tray 204 disposed in a different position.

The movable tray 204 may be a rigid or semi-rigid member that is capable of being moved between a stowed position disposed within the housing 206 (illustrated in FIGS. 2B and 2C), and a deployed position, extending out of the housing 206 (illustrated in FIG. 2D). The movable tray 204 may be engaged with the accessory loop such that upon moving the movable try 204 to the deployed position, the tray 204 is to extend the accessory loop out of the housing such that the accessory loop can receive an accessory. In some implementations, the movable tray 204 may be slid or translated between the stowed position and the deployed position. The movable tray 204 may be substantially planar or flat, such that it may be slid or moved smoothly through a window or opening in the housing 206, and/or so that the accessory loop may be folded on to the movable tray 204 and compressed sufficiently so as to be able to slide back into the housing 206.

When disposed in the stowed position, the movable tray 204 may be substantially flush with an exterior surface 216 of the housing 206. As such, when the accessory dock 200 is not being utilized, it is effectively hidden and the industrial design or aesthetic of the housing and electronic device is maintained. In this context, substantially flush refers to the outermost portion of the tray 204 being sufficiently aligned or flat with the exterior surface 216 such that it does not detract from the aesthetic appearance of the electronic device or housing 206.

In some implementations, the movable tray 204 may include a removal lever 208 to transition or move the tray 204 or assist therewith, especially in examples wherein the movable tray 204 sits flush with the exterior surface 216. The removal lever 208 may be attached to the movable tray 204 such that it can move relative to the tray 204. In some implementations, the removal lever is pivotally attached to the tray 204, for example, by pivot 210. The removal lever 208 may be movable relative to the tray 204 such that the removal lever 208 is pushable relative to the movable tray 204 at a first portion 212 of the lever 208, illustrated by FIG. 2B. The removal lever 208 may also be pullable relative to the movable tray 204 at a second portion 214, illustrated by FIG. 2C. The second portion 214 may be opposite from the first portion 212. In some implementations, the first portion 212 may be a first distal end of the removal lever 208, and the second portion 214 may be the opposite distal end of the lever 208, with the pivot 210 being disposed in between the first and second portions 212 and 214. Stated differently, in some examples, in order to move the movable tray 204 from the stowed position to the deployed position, a user may press on the removal lever 208 at a first portion 212, thereby ejecting the second portion 214 from sitting flush with the exterior surface 216 of the housing 206. The user may then grab on to and pull the second portion 214 of the removal lever 208 in order to slide or pull the movable tray 204 to the deployed position, as illustrated by FIG. 2D. In some implementations, the movable tray 204 may include a different component or components to assist in deploying the tray, such as a push-to-eject (or push-push) mechanism, a knob or protrusion to grab on to, or some other type of component.

The movable tray 204 may further include a retention post 218 extending from the movable tray 204 in a direction towards the accessory loop. The accessory loop may include a complementary aperture extending through a portion of the loop to engage with the retention post 218 such that, upon the movable tray 204 being transitioned to the stowed position, the movable tray 204 (or the retention post 218 thereon) may insert or pull the accessory loop into the housing 206 in order to stow the accessory loop in a hidden manner. Similarly, upon the movable tray 204 being transitioned to the deployed position, the movable tray 204 (or the retention post 218 thereon) may pull or extend the accessory loop out of the housing such that the accessory loop may receive an accessory. In some implementations, the movable tray 204 may have a plurality of retention posts 218, e.g., a pair of retention posts 218 as illustrated in FIG. 2A, and the accessory loop may have a matching number of complementary apertures each to engage with or receive one of the plurality of retention posts 218. Having a plurality of retention posts 218 may increase the engagement surface area between the tray 204 and the accessory loop, thereby increasing the ease with which the movable tray 204 may eject or stow the accessory loop.

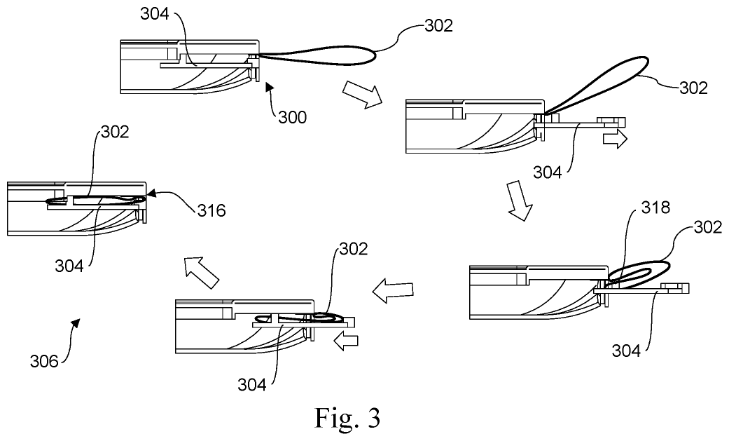

Referring now to FIG. 3, a cutaway side view of a portion of an example housing 306 having an example stowable accessory dock 300 in various positions is illustrated. Example stowable accessory dock 300 may be similar to other example accessory docks described above. Further, the similarly-named elements of example accessory dock 300 may be similar in function and/or structure to the respective elements of other example accessory docks, as they are described above. Stowable accessory dock 300 may include an accessory loop 302 and a movable tray 304, each movable between a stowed position disposed within the housing 306, and a deployed position, extending out of the housing 306.

Starting at the top-left view of FIG. 3, the accessory loop 302 may be in the deployed position and able to receive an accessory and retain such accessory to the housing 306 and/or the electronic device with which the housing 306 is employed. Referring to the views in a clockwise manner, a user may desire to no longer have the accessory loop 302 deployed, and/or may wish to improve the aesthetic of the housing 306. In order to move the accessory loop 302 to the stowed position, the movable tray 304 may be ejected or transitioned from the stowed position to the deployed position, e.g., as described above with regard to FIGS. 2A-2D. Thereupon, the accessory loop 302 may be folded on to itself in order to lay flat and fit on the movable tray 304. In some implementations, the accessory loop 302 may be folded back on itself approximately 180 degrees to fit on to the movable tray 304. In examples wherein the movable tray 304 has retention post(s) 318 and the accessory loop 302 has complementary apertures to receive such retention posts 318, each retention post 318 may be inserted into a corresponding complementary aperture in order to retain or hold the accessory loop 302 in the folded position on the movable tray 304.

Once the accessory loop 302 is folded or otherwise laying against the movable tray 304, the movable tray 304 may be inserted back into the housing 306 to the stowed position, pulling the accessory loop 302 with it, thus hiding the accessory loop 302 from view. In order to deploy the accessory loop 302 for use, the previous steps may be substantially reversed. In other words, the movable tray 304, with the accessory loop 302 thereon, may be ejected or removed from the stowed position to the deployed position. The accessory loop 302 may then be unfolded and/or removed from engagement with the retention posts 318, thereby now being able to receive an accessory. The movable tray 304 may then be pushed back into the housing 306 in order to hide the tray 304, leaving the accessory loop 302 in the deployed and ready-to-use position.

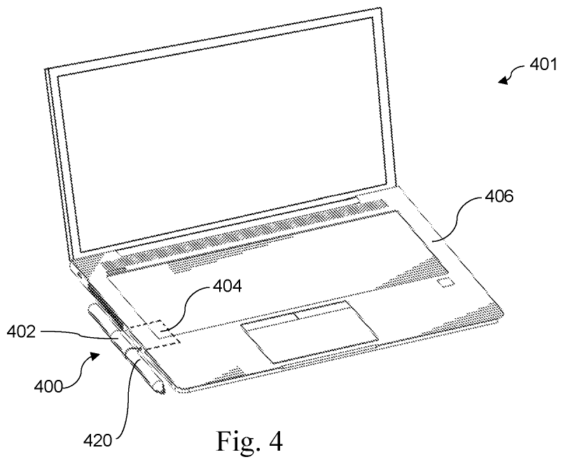

Referring now to FIG. 4, a perspective view of an example electronic device 401 having an example stowable accessory dock 400 disposed in a housing 406 is illustrated. Example stowable accessory dock 400 may be similar to other example accessory docks described above. Further, the similarly-named elements of example accessory dock 400 may be similar in function and/or structure to the respective elements of other example accessory docks, as they are described above. Example stowable accessory dock 400 may include an accessory loop 402 to receive, hold on to, or otherwise retain an accessory 420 to the electronic device 401. The stowable accessory dock 400 may also include a movable tray 404 (shown in phantom as being disposed within the housing 406) to transition the accessory loop 402 between a stowed position and a deployed position as illustrated in FIG. 4.

In some implementations, the electronic device 401 may be a computing device such as a desktop computer, a laptop or notebook computer, a tablet, smartphone, or the like. In other examples, the electronic device 401 may be another type of device with which it may be beneficial to use or have an accessory. Such other devices may include imaging devices such as printers, scanners, copiers, or additive manufacturing devices such as 3D printers.

The electronic device 401 may include a housing 406 to enclose and/or support components of the electronic device 401. Such components may include storage drives, displays, processors, or other suitable components. In some implementations, the electronic device 401 may include an accessory 420 to be used in conjunction with the electronic device 401. Such accessories may include a stylus, electronic pen, or the like for use with a touch-screen display of the electronic device. In some implementations, the accessory 420 may be a standard pen or pencil, or some other type of thin and/or elongate component that may be able to fit within and be retained by the accessory loop 402 of the stowable accessory dock 400. As described above, the accessory loop 402 may be moved from the stowed position within the housing 406 to the deployed position, extending from the housing 406 (as illustrated) by way of the movement of the movable tray 404 if/when a user of the electronic device 401 wishes to stow the accessory 420 and not use it anymore. Once the accessory loop 402 is deployed, the user may insert the accessory 420 into an internal recess, channel, cavity, or other opening defined by the pliable material of the accessory loop 402 in order to stow and retain the accessory 420 to the electronic device.

What is claimed is:

1. A stowable accessory dock, comprising:
an accessory loop; and
a movable tray adjacent the accessory loop that is movable between a stowed position disposed within a housing of a computing device and a deployed position extending out from the housing of the computing device,
wherein the accessory loop is engageable with the tray such that the tray is to insert the accessory loop into the housing upon the tray being transitioned to the stowed position.

2. The stowable accessory dock of claim 1, wherein the movable tray comprises a retention post to engage with a complementary aperture in the accessory loop such that the retention post is to pull the accessory loop into the housing of the computing device upon the tray being transitioned to the stowed position.

3. The stowable accessory dock of claim 2, wherein the accessory loop is engageable with the tray such that the tray is to extend the loop outside of the housing upon the tray being transitioned to the deployed position.

4. The stowable accessory dock of claim 3, wherein the retention post is to engage with the complementary aperture in the accessory loop such that the retention post is to pull the accessory loop outside of the housing upon the tray being transitioned to the deployed position.

5. The stowable accessory dock of claim 1, wherein the movable tray comprises a removal lever to transition the tray from the stowed position to the deployed position.

6. The stowable accessory dock of claim 5, wherein the removal lever is pivotably attached to the tray such that it is pushable relative to the tray at a first portion of the lever and pullable relative to the tray at a second portion, opposite from the first portion.

7. The stowable accessory dock of claim 6, wherein the removal lever is to sit substantially flush with an exterior surface of the housing when the movable tray is disposed in the stowed position.

8. The stowable accessory dock of claim 1, wherein the accessory loop comprises a pliable material so as to be folded on to the movable tray.

9. A housing for a computing device, comprising:
a stowable accessory dock, comprising:
an accessory loop to receive an accessory; and
a moveable tray adjacent the accessory loop having a retention post and that is moveable between a stowed position disposed within the housing and a deployed position extending out from the housing,
wherein the accessory loop includes a complementary aperture to engage with the retention post such that, upon the movable tray being transitioned to the stowed position, the movable tray is to insert the accessory loop into the housing and, upon the movable tray being transitioned to the deployed position, the movable tray is to pull the accessory loop out of the housing.

10. The housing of claim 9, wherein the movable tray further comprises a removal lever pivotally attached to the movable tray to transition the tray from the stowed position to the deployed position.

11. The housing of claim 10, wherein the removal lever is pushable at a first portion of the lever, wherein, upon the first portion being pushed, a second portion, opposite the first portion, extends from an exterior surface of the housing.

12. An electronic device, comprising:
a housing; and
a stowable accessory dock disposed in the housing, comprising:
an accessory loop; and
a moveable tray adjacent the accessory loop that is moveable between a stowed position disposed within the housing and a deployed position extending out from the housing of the electronic device,
wherein the accessory loop is engaged with the movable tray such that upon moving the movable tray to the deployed position, the tray is to extend the accessory loop out of the housing such that the accessory loop can receive an accessory.

13. The electronic device of claim 12, wherein the movable tray includes a pair of retention posts and the accessory loop includes a pair of complementary apertures to each engage with one of the pair of retention posts.

14. The electronic device of claim 13, wherein the accessory loop is pliable such that it is to be folded on to the movable tray when the movable tray is disposed in the deployed position.

15. The electronic device of claim 12, further comprising an accessory to insert into the accessory loop upon the accessory loop being disposed outside of the housing.
